(19) United States
(12) Patent Application Publication
(10) Pub. No.: US 2009/0012939 A1
(43) Pub. Date: Jan. 8, 2009

(54) Information Presentation Method and Apparatus

(76) Inventors: Masahiro Kato, Tokyo (JP); Junichi Kimura, Koganei (JP); Nobuhiro Sekimoto, Yokohama (JP); Minako Toba, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/145,694

(22) Filed: Jun. 25, 2008

(30) Foreign Application Priority Data
Jun. 29, 2007 (JP) 2007-171376

(51) Int. Cl. G06F 17/30

(52) U.S. Cl. 707/3; 707/E17.022

(57) ABSTRACT

A method of extracting a keyword in synchronism with a “scene” or “corner” in a TV program that changes in units of second in synchronism with the elapse of time of first content, and an information presentation apparatus to search and display a predetermined form of content, such as a web page, are provided. The information presentation apparatus comprises: an AV content output unit to output AV content (e.g., TV programs and movies); and a web page output unit to output, together with the AV content from the AV content output unit, a web page that corresponds to a keyword related to a scene included in the content being output from the AV content output unit without the user having to take trouble to choose a keyword, the web page output unit being adapted to, when the scene in the content changes, automatically update the web page to one corresponding to the changed scene.

### INCORPORATION BY REFERENCE

The present application claims priority from Japanese application JP2007-171376 filed on Jun. 29, 2007, the content of which is hereby incorporated by reference into this application.

### BACKGROUND OF THE INVENTION

1. Field of the Invention

The present invention relates to a search of information and/or a presentation of search results. More particularly it relates to a method of searching information via the Internet, an information display apparatus for displaying searched information, and a program for executing information search and display. More specifically it relates to a technology suitably applied to an apparatus, such as a television set, that displays content, such as broadcasting programs.

2. Description of the Related Art

As for the field of the invention described above, JP-A-2005-115790 “Information Search Method, Information Display Apparatus and Program”, for instance, has a task of “being able to easily search various pieces of information from wide ranges of areas without requiring special, complex operations”. To achieve this objective, JP-A-2005-115790 “performs a series of operations that involves, for example, displaying first content such as received broadcast programs, extracting and displaying keywords associated with the displayed first content, searching second content of a predetermined form, such as a web page on the Internet based on the displayed keyword, and displaying the second content obtained”. Furthermore, as the keywords a plurality of pieces of information associated with the program are displayed for a user to choose.”

### SUMMARY OF THE INVENTION

JP-A-2005-115790, however, has a drawback that even when there are very many keywords associated with first content, there is no alternative but to display a list of keywords at one time for the user to choose in making a search for second content. The user may therefore be under stress by being forced to select one keyword from the list of a huge number of keywords. The above patent document also fails to give enough consideration to narrowing a range of keywords for user selection.

Under these circumstances, therefore, the present application provides an information presentation method and a program for extracting keywords synchronized with a “scene” and “corner” of a television program as the first content that changes in units of seconds and/or searching and displaying content of a predetermined form, such as web pages based on the extracted keywords.

For example, an information presentation apparatus may comprise an AV content output unit to output AV content (e.g., TV programs and movies) and a web page output unit that outputs, along with the AV content from the AV content output unit, a web page corresponding to a keyword associated with a scene in the content being output from the AV content output unit, rather than requiring the user to take trouble to select a keyword, and which, when the scene in the content changes, automatically updates the web page to one that corresponds to the changed scene.

The present invention can therefore provide a TV viewing environment that allows even a user not used to complicated operations of an AV equipment to view associated web pages while watching TV programs.

### BRIEF DESCRIPTION OF THE DRAWINGS

These and other features, objects and advantages of the present invention will become more apparent from the following description when taken in conjunction with the accompanying drawings wherein:

FIG. 1 is a block diagram showing a hardware configuration of the apparatus;

FIG. 2 illustrates an example of a first interface screen for the information search method and the information display apparatus;

FIG. 3 illustrates an example of a second interface screen for the information search method and the information display apparatus;

FIG. 4 illustrates an example of functional configuration of the apparatus;

FIG. 5 illustrates an example configuration of a keyword list generation unit;

FIG. 6 illustrates an example configuration of a key word management unit;

FIG. 7 illustrates an example of a keyword list;

FIG. 8 illustrates an example configuration of a web page retrieving unit;

FIG. 9 illustrates an example of a web page priority order list 3003; and

FIG. 10 illustrates an example configuration of an information display unit 1004.

### DETAILED DESCRIPTION OF THE EMBODIMENT

A preferred embodiment of the present invention will be described. It is noted however that the invention is not in any way limited to this embodiment.

This embodiment relates to an information search method for searching information via the Internet, an information display apparatus for displaying searched information and a program for executing information search and display, and more specifically to a technology suitably applied to such apparatus as audiovisual (AV) equipment (television receivers, recorders and set top boxes), that output AV content such as broadcast programs and movies.

### <Hardware Configuration>

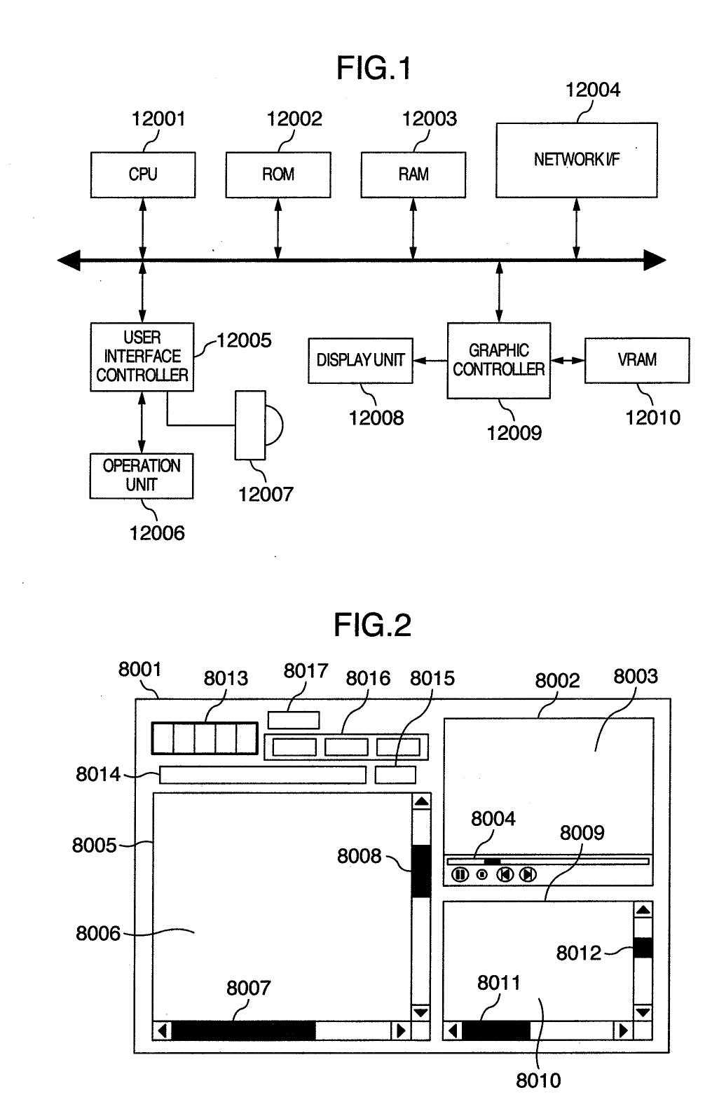

FIG. 1 shows an example hardware configuration of the apparatus. The apparatus of this embodiment is shown to have (incorporate) a display unit capable of displaying moving images and is applicable to a variety of information display apparatus such as television receivers and computers. It is noted, however, that the display unit may be a separate one (external device). The display unit, whether it is a built-in device or an external device, is also generally called information presentation apparatus.

A central processing unit (CPU) 12001 that controls an operation of the apparatus is connected with a ROM 12002 and a RAM 12003 via an internal bus line. The apparatus also has a network interface 12004 to connect with external networks. The CPU 12001 functions as a control unit that executes an information search operation described later, and the connected memories 12002, 12003 also function as a storage unit for a keyword list described later. Further a program to execute the information search operation is stored in the ROM 12002 or RAM 12003. Based on the program, the CPU 12001 executes the information search operation. The storage unit such as RAM 12003 may use hard disks in addition to a semiconductor memory, and also a removable device such as memory card. When a large capacity storage unit (recording unit) is used, the apparatus in the case of a television receiver for example may have a recording function of accumulating broadcast programs.

Possible devices for the network interface 12004 include, for example, analog modem for analog telephone circuit, modem for ISDN circuit, router or modem for ADSL (Asymmetric Digital Subscriber Line), adapter for LAN (Local Area Network), adapter for wireless telephone and adapter for wire communication such as Bluetooth (trademark). Through this interface 12004 the apparatus can connect to the Internet.

Further, the apparatus includes a graphic controller 12009 that performs a display control on various pieces of information and moving images. The graphic controller 12009 is connected with a VRAM 12010 that holds video data. Video generated by the graphic controller 12009 is displayed on a display unit 12008. As the display unit 12008 a liquid crystal display panel may be used. The display unit 12008 may also display videos (images) produced by video signals received by a tuner not shown or video signals supplied from outside (e.g., video signals played back by a video player). Video from these video signals and video from a web page on the Internet described later can be displayed simultaneously on a single screen by the control of the graphic controller 12009. It is also possible to display character-based information, such as keywords described later, superimposed on the video image.

The apparatus also includes an operation unit 12006 with various operation keys and operation buttons, and a user interface controller 12005 to accept operations performed by the operation unit 12006. The operation data accepted by the user interface controller 12005 is sent to the CPU 12001. Infrared signals received by a light receiving unit 12007 is checked by the user interface controller 12005, allowing for a remote control from a remote control device.

In FIG. 1 and the following explanations, since descriptions will center around the search operation based on the displayed information and the display of the search result, details of the fundamental configuration of those devices that receive and play back AV content of MPEG format, including a broadcast signal receiving tuner, a demultiplexer (demux) and a decoder, are not shown here. But they are equipped in this apparatus.

### <Example Screen>

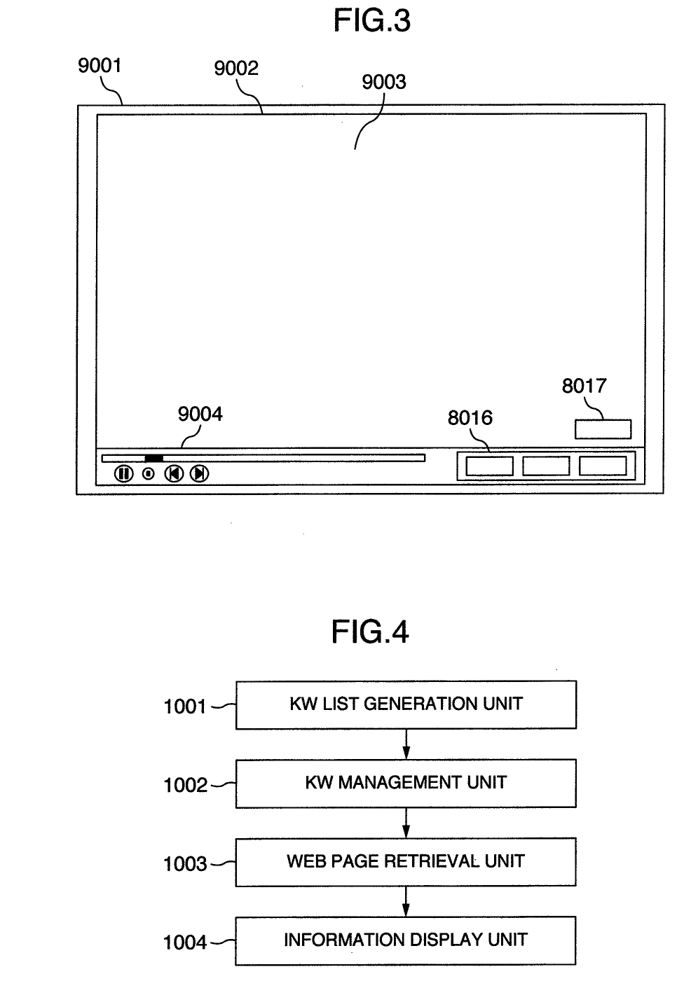

Referring to FIG. 2 and FIG. 3, an explanation will be given to an example structure of an interface screen displayed on the display unit 12008 to accept an instruction input from the user interface controller 12005. In FIG. 3 a web page display area of FIG. 2 is shown contracted while a TV program display area is shown expanded.

Although a web page is shown as an example information source from which to obtain AV content-related information, with a TV program used as an example of AV content, it should be noted that the information source may be otherwise. For example, it may be a built-in electronic encyclopedia. The AV content may be DVD-recorded movies and movies distributed via Internet. The information source from which to extract AV content-related information may be information incorporated in the apparatus.

Each of interface elements in the interface screen 8001 of FIG. 2 will be explained.

A TV program display screen 8002 includes a TV picture display area 8003 and a TV display operation area 8004 having a TV picture display temporary halt button, a stop button, a backward button, a forward button and a TV content scroll bar. Those functions the TVs conventionally have, including TV channel selection buttons and a sound volume adjust button, may be mounted on a remote controller as in the conventional TVs or added to the TV display operation area 8004. The TV display operation area 8004 may also be provided with a function that moves a predetermined length of time backwards and displays the video forwardly from there, such as a button that moves back by 10 minutes.

Web page display screens 8005, 8009 have web page display areas 8006, 8010, horizontal scroll bars 8007, 8011 and vertical scroll bars 8008, 8012, respectively. The web page display screen 8005 displays a web page that has been searched using a keyword extracted from videos, subtitles, telops, data broadcast and text broadcast. The web page display screen 8009 displays an electronic table of programs and a list of recorded programs.

Backward button, forward button, update button and home button that standard browsers have to control a web page are arranged in a web page control button group 8013.

A web page address input area 8014 and a search execute button 8015 have the same functions as those of the standard browsers.

A keyword display area 8016 displays three keywords, extracted in synchronism with the elapse of time of a TV program, in reverse chronological order. The number of keywords displayed in the keyword display area 8016 may be set such that the user will not feel a stress as he or she browses them.

A broadcast time display area 8017 shows an elapse of time of the program being broadcast in the form of # hours # minutes # seconds with the broadcast start time of the TV program set at 0 hour 0 minute 0 second.

FIG. 3 shows an interface screen 9001 for the information search method and the information display apparatus. The interface screen 9001 has the web page display screens 8005, 8009, the web page control button group 8013, the web page address input area 8014 and the search execute button 8015 of FIG. 2 shown minimized and the TV program display screen 8002 shown expanded. The TV program display screen 8002 is comprised of the following interface elements.

The TV program display screen 9002 has a TV picture display area 9003, a TV display operation area 9004 with a TV picture display temporary halt button, a stop button, a backward button, a forward button and a TV content scroll bar. As in the explanation of FIG. 2, those functions the TVs conventionally have, including TV channel selection buttons and a sound volume adjust button, may be mounted on a remote controller as with the conventional TVs or added to the TV display operation area 9004. The TV display operation area 9004 may also be provided with a function that moves a predetermined length of time backwards and displays the video forwardly from there, such as a button that moves back by 10 minutes.

### <Functional Configuration of Apparatus>

FIG. 4 is a block diagram showing an example configuration of functions of the information presentation apparatus, i.e., the functions that the CPU 12001 executes using programs and data stored in the storage unit such as ROM 12002, RAM 12003 and HDD.

The information presentation apparatus has a keyword list generation unit 1001, a keyword management unit 1002, a web page retrieval unit 1003 and an information display unit 1004. In the following description, a keyword is also referred to as KW.

### <KW List Generation Unit 1001>

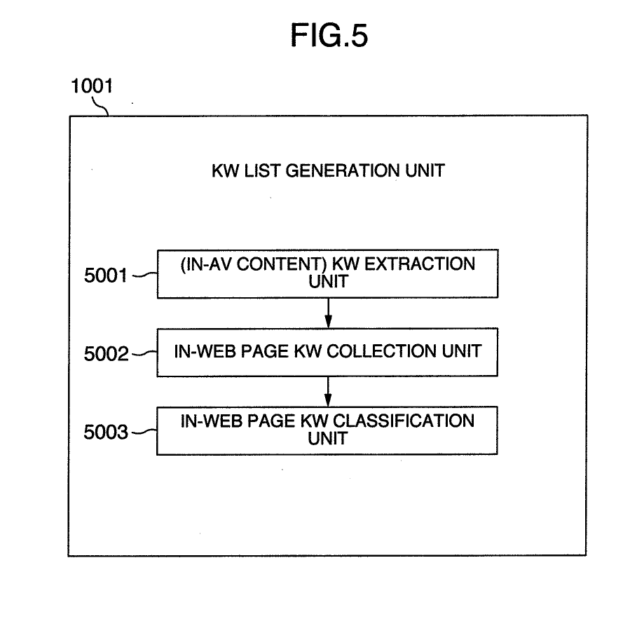

FIG. 5 shows a detail of the keyword (KW) list generation unit 1001.

A KW extraction unit 5001 extracts keywords (KW's in a program or KW's in AV content) from videos, subtitles, telops, data broadcast and text broadcast, all making up the TV program.

An in-web page KW collection unit 5002 checks in advance (before playback or reception of AV content) web pages registered with a web page preferential order list 3003 held in a web page selection unit 3002 and gathers keywords found in the web pages (keywords in web pages and keywords in web content).

An in-web page KW classification unit 5003 checks a genre-based dictionaries not shown, determines genres represented by keywords in the web pages gathered by the in-web page KW collection unit 5002 and genres represented by web pages that contain the in-web page keywords and classifies the in-web page keywords into news, sports, music, shopping, finance and others.

The in-web page KW collection unit 5002 and the in-web page KW classification unit 5003 allow an irrelevant KW discarding unit 2007 described later to eliminate irrelevant keywords, preventing the user from having to look at unnecessary keywords and web pages searched based on the keywords. Of the two units, only the in-web page KW collection unit 5002 may be used. Or none of them may be used. “KW candidate list” represents a list of keywords in a web page, which is output by the in-web page KW collection unit 5002.

### <KW Management Unit 1002>

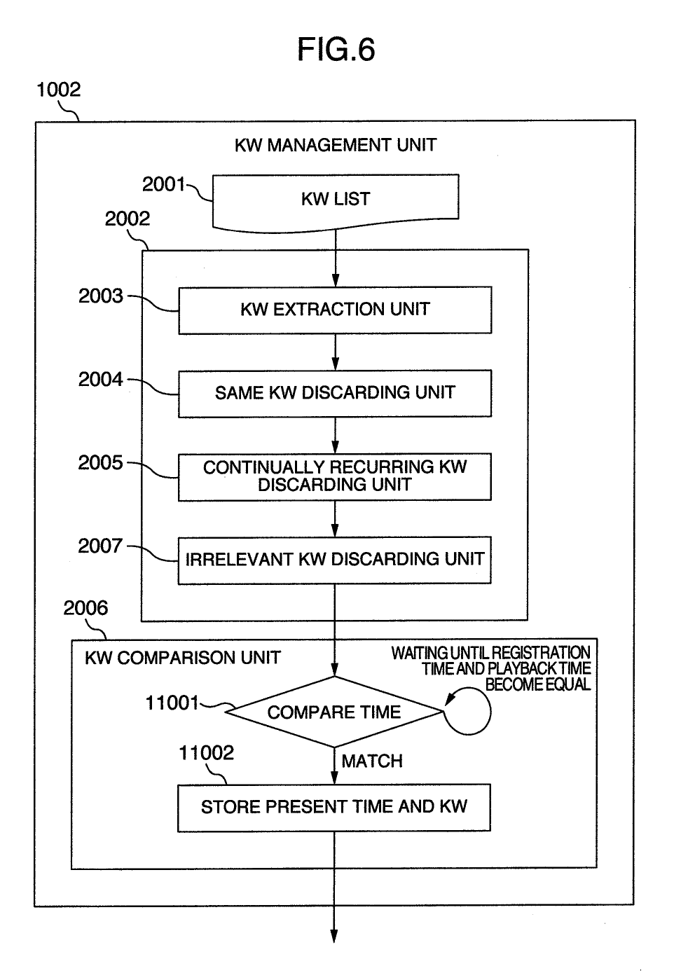

FIG. 6 shows a detail of the KW management unit 1002.

The KW management unit 1002 has a KW list 2001 in which a plurality of pairs of KW and its occurrence time can be registered, a KW selection unit 2002 and a KW comparison unit 2006 that compares a registered time, paired with the extracted keyword, with a broadcast time of a TV program and, if they match, issues a notification that they have matched.

The KW selection unit 2002 is comprised of a KW retrieval unit 2003 that retrieves keywords registered with the KW list 2001 in chronological order, a same KW discarding unit 2004 that compares a newly retrieved keyword with an immediately preceding keyword and, if they are found to be the same keywords, discards the newly retrieved keyword, and a continually recurring KW discarding unit 2005 that compares an occurrence time of a newly retrieved keyword with that of an immediately preceding keyword and, if they are found to fall within a predetermined time interval, discards the newly retrieved keyword.

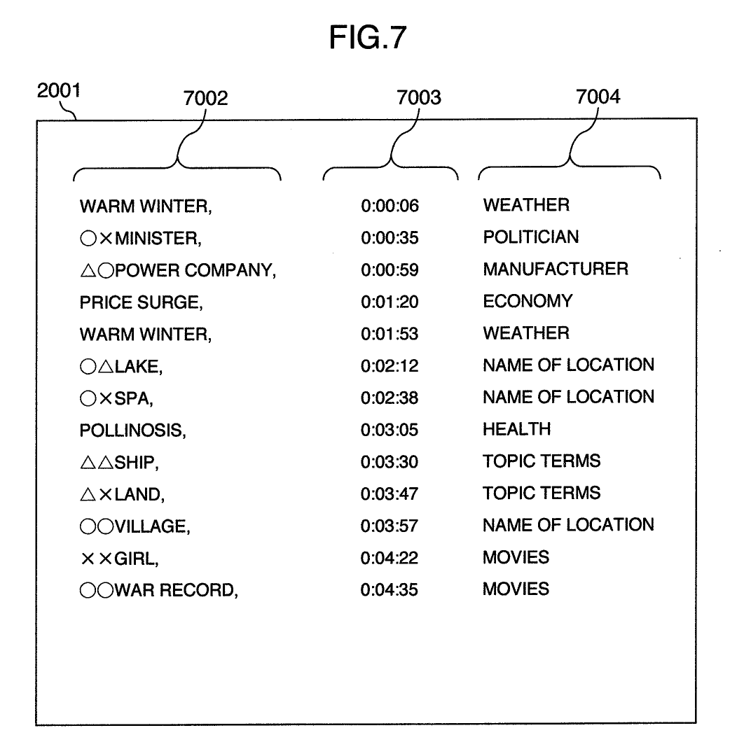

FIG. 7 shows an example of the KW list 2001. The KW list 2001 can register a plurality of KW 7002 paired with its occurrence time 7003 and genre 7004. The KW list 2001 is output from the KW list generation unit 1001.

The KW list 2001 comprises a KW list and a second KW list. The first KW list is a list of keywords that the in-AV content KW extraction unit 5001 making up the KW list generation unit 1001 has successively extracted in synchronism with an AV content playback time. The second KW list is a list of keywords extracted by the in-web page KW collection unit 5002 that are each attached with an associated genre by the in-web page KW classification unit 5003.

The KW retrieval unit 2003 retrieves keywords registered with the KW list 2001 in chronological order. Then the same KW discarding unit 2004 and the continually recurring KW discarding unit 2005, whose operation will be explained later, perform keyword discarding sessions to select effective keywords.

The same KW discarding unit 2004, when the same keywords are retrieved successively in time frame, discards the second and subsequent keywords. The same KW discarding unit 2004 thus can avoid a situation where a search of the same web page is repeated with the same keyword.

When a time interval between the occurrence time of a newly retrieved keyword and that of an immediately preceding keyword is short, the continually recurring KW discarding unit 2005 discards the newly retrieved keyword. The continually recurring KW discarding unit 2005 thus prevents a search of the next web page from being initiated before the user can take a good look at the retrieved web page.

The irrelevant KW discarding unit 2007 checks a newly retrieved keyword against the second KW list including in-web page keywords and, when the keyword is found to match no in-web page keywords, discards the newly retrieved keyword. If a genre of the newly retrieved keyword fails to match any of those of the in-web page keywords, the irrelevant KW discarding unit 2007 also rejects the newly retrieved keyword. Thus, if a keyword or its genre does not match any of the already searched in-web page keywords or their genres, the keyword is rejected lowering a probability of web content irrelevant to the TV program being searched and displayed. It is also possible not to consider genre but to only consider a keyword.

The KW comparison unit 2006 in step 11001 compares a registered time paired with the retrieved keyword with a broadcast time of a TV program to find a matching time. In step 11002, the KW comparison unit 2006 stores the present time and the keyword. When the KW retrieval unit 2003 picks up a next new keyword and its occurrence time, the present time of the keyword stored as described above is used as the occurrence time of the immediately preceding keyword for comparison, to be performed by the continually recurring KW discarding unit 2005, with the occurrence time of the new keyword.

### <Web Page Retrieval Unit 1003>

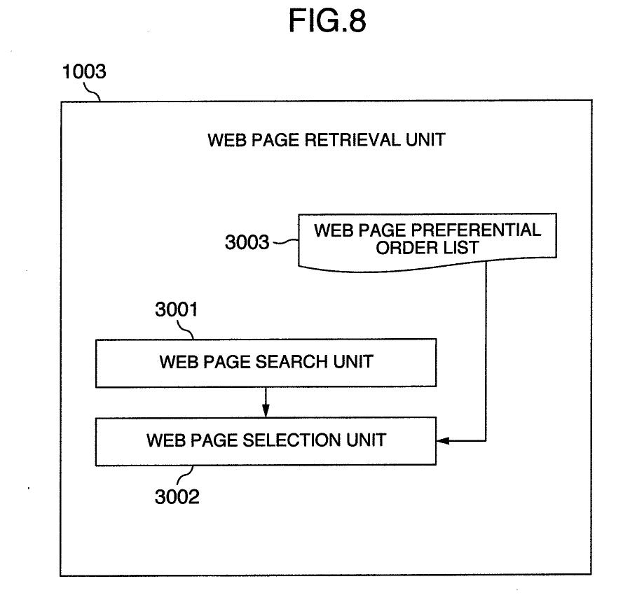

FIG. 8 shows details of the web page retrieval unit 1003.

The web page retrieval unit 1003 has a web page search unit 3001 that searches the Internet based on the keyword selected by the KW selection unit 2002; and a web page selection unit 3002 that determines which of a plurality of web pages searched by the web page search unit shall be displayed according to the web page preferential order list 3003.

The web page search unit 3001 enters the keyword chosen by the KW selection unit 2002 into a predetermined search site to execute a search. The web page search unit 3001 also matches the time of a web page detection to the search result (web page found by the search) in order to synchronize the KW comparison unit 2006 with the time of detection.

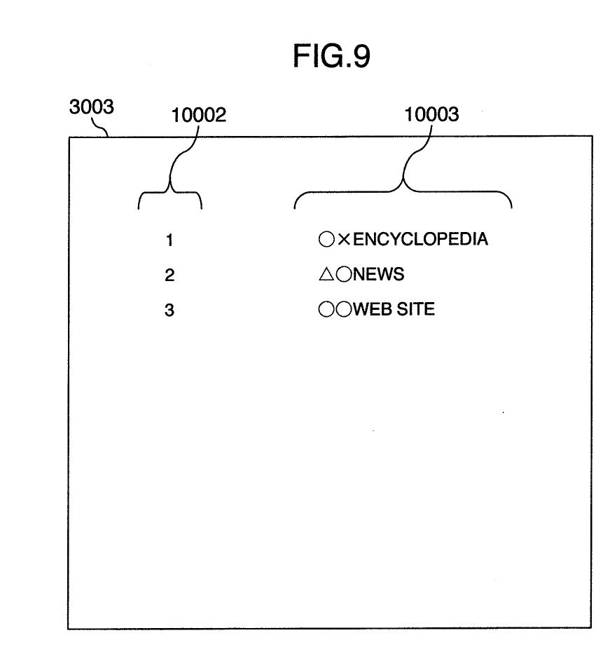

FIG. 9 shows an example of the web page preferential order list 3003. The web page preferential order list 3003 registers content of a predetermined form, such as web pages, and their order of preference and includes content names 10003 and a priority order 10002. The content names 10003 present information (names, URL, etc.) that allows content of a predetermined form, such as web page, to be identified.

The web page selection unit 3002 selects, according to the web page preferential order list 3003 of FIG. 9, one of the web pages found by the web page search unit 3001.

The following process reverse to what has been explained may be adopted. That is, the process involves holding a preferential order of search sites in the web page preferential order list 3003, selecting a search site of first priority order by the web page selection unit 3002, executing the search by the web page search unit 3001, and, if the search result is zero web pages, selecting a search site of second priority order by the web page selection unit 3002. In this way, the search sites may be selected in the preferential order and the web pages thus found retrieved.

### <Information Display Unit 1004>

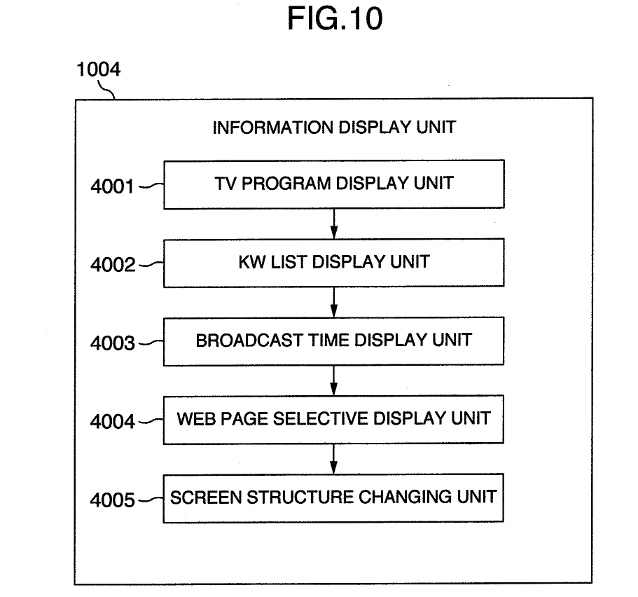

FIG. 10 shows details of the information display unit 1004.

The information display unit 1004 comprises a TV program display unit 4001 that displays videos, subtitles, telops, data broadcast and text broadcast, all making up TV programs; a KW list display unit 4002 that displays en masse a predetermined number of keywords picked up by the KW selection unit 2002 in an inverted chronological order; a broadcast time display unit 4003 that displays an elapse of time of the program being broadcast in the form of # hours # minutes # seconds with the broadcast start time of the TV program set at 0 hour 0 minute 0 second; a web page selective display unit 4004 that selectively displays a particular part of content, as by displaying only a text body excluding advertisements and decorative display portions; and a screen structure changing unit 4005 that changes a display area for the TV program display unit 4001 and a display area for the web page selective display unit 4004 either at a predetermined timing or by user operations.

The TV program display unit 4001 displays videos, subtitles, telops, data broadcast and text broadcast, all making up TV programs, in the TV picture display area 8003 of FIG. 2.

The KW list display unit 4002 displays en masse a predetermined number of keywords picked up by the KW selection unit 2002 in the keyword display area 8016 in reverse chronological order. From what is shown in the keyword display area 8016 it is possible to determine from which keyword the content of a predetermined form currently being displayed, such as web page, has been searched.

The broadcast time display unit 4003 displays in the broadcast time display area 8017 an elapsed time of the TV program being broadcast in the form of # hours # minutes # seconds with the broadcast start time of the TV program set at 0 hour 0 minute 0 second. From this information the relation between the broadcast time and the keyword can be known, so it is possible to specify a desired part of content, such as a web page, that is being displayed in synchronism with the TV program, by simply giving a time instruction, such as “go back to 10 minutes before”.

The web page selective display unit 4004, according to the display format of the predetermined form of content, such as a web page, that has been searched based on the keyword, selectively displays a particular part of the content in the web page display area 8006, as by displaying only a text body excluding advertisements and decorative display portions. This allows an important part of the web page to be selectively displayed even in an narrow display area.

The screen structure changing unit 4005 changes a display area of the TV program display screen 8002 and a display area of the web page display screen 8005 displayed by the web page selective display unit 4004 either at a predetermined timing or by user operations. When, for example, a new keyword search is executed and a web page is updated, the interface screen 8001 of the apparatus presented to the user is structured as shown in FIG. 2. After this, if a predetermined time passes without the web page being updated, the screen structure is changed to what is shown in FIG. 3. When a predetermined time passes after the screen structure changing unit 4005 has searched and displayed a web page according to the latest keyword selected by the KW selection unit, it automatically minimizes the web page display area and instead expands the TV program display area. Thus, the user is free of a stress that he or she would feel if they have to watch TV programs in a small screen at all times.

In the above embodiment, the user of the apparatus is able to simply watch a TV screen without becoming much conscious of how to select a keyword associated with the TV program from a list or how to enter a keyword from a keyboard, and still able to search and display a predetermined form of content, such as a web page, based on the keyword in synchronism with a scene included in the TV program. As described above, since the user does not have to change the conventional TV viewing style, a TV viewing environment can be realized in which the user, if not accustomed to a complicated operation of AV equipment, can browse associated web pages while watching a TV program.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

1. An information presentation apparatus comprising:
an AV content output unit to output AV content; and
a web page output unit to output, together with the AV content from the AV content output unit, a web page that corresponds to a keyword related to a scene included in the content being output from the AV content output unit.

2. An information presentation apparatus, according to claim 1,
wherein, when the scene in the content changes, the web page output unit updates the web page to one corresponding to the changed scene and outputs the updated web page.

3. An information presentation apparatus, according to claim 1, further including:
a web page search unit to execute a search based on a keyword related to the scene included in the content being output from the AV content output unit.

4. An information presentation apparatus, according to claim 1, further including:
a keyword output unit to display a keyword related to the scene included in the content being output from the AV content output unit; and
a switching unit to switch between an output from the web page output unit and an output from the keyword output unit.

5. An information presentation apparatus, according to claim 1, further including:
a keyword extraction unit to extract from subtitles, telops, data broadcast and text broadcast included in the AV content a keyword related to the scene included in the content being output from the AV content output unit.

6. An information presentation apparatus, according to claim 1, wherein the web page output unit outputs a text portion of the web page.
